(19) United States
(12) Patent Application Publication
(10) Pub. No.: US 2026/0171292 A1
(43) Pub. Date: Jun. 18, 2026

(54) MAGNETIC UNIT

(71) Applicant: Yazaki Corporation, Tokyo (JP)

(72) Inventors: Masayo MATSUURA, Shizuoka (JP); Takuto MISHIGE, Shizuoka (JP); Kenji SEGAWA, Shizuoka (JP); Takanori KANAMORI, Shizuoka (JP); Junya ISHIDA, Shizuoka (JP)

(73) Assignee: Yazaki Corporation, Tokyo (JP)

(21) Appl. No.: 19/419,285

(22) Filed: Dec. 15, 2025

(30) Foreign Application Priority Data
Dec. 16, 2024 (JP) 2024-219711

(51) Int. Cl. H01F 27/24; H01F 27/02

(52) U.S. Cl. CPC H01F 27/24; H01F 27/02

(57) ABSTRACT

A magnetic unit includes a magnetic core including a first core and a second core that are split, a base member that accommodates the magnetic core and includes a bottom part that supports the first core and a sidewall part that is provided on a side of the magnetic core, and a plate spring with an end part held by the sidewall part, the plate spring serving as a biasing member to bias the second core to the other side in the third direction. The sidewall part includes a biasing member holding part that is locked to the end part of the plate spring.

### CROSS-REFERENCE TO RELATED APPLICATION(S)

The present application claims priority to and incorporates by reference the entire contents of Japanese Patent Application No. 2024-219711 filed in Japan on Dec. 16, 2024.

### BACKGROUND OF THE INVENTION

### 1. Field of the Invention

The present invention relates to a magnetic unit.

### 2. Description of the Related Art

As one example of the conventional art regarding a magnetic unit, Japanese Patent Application Laid-open No. H5-47565 discloses a magnetic unit including a case made of synthetic resin equipped with a hinge part that can be opened and closed and locking means, a two-part magnetic core molded into a spinning pyramid shape that is accommodated in the case, and a biasing member interposed and held between the case and the magnetic core. In this magnetic unit, as the case is closed, shut, and locked by the locking means, the biasing member presses the two-part magnetic core so as to press-fit the split surfaces of the magnetic core against each other.

Incidentally, such a magnetic unit may require, for example, sub-assembling of assembling the biasing member in advance to the case before the case is closed and the magnetic core is press-fitted. There is room for further improvement in the configuration for assembling the biasing member to the case.

### SUMMARY OF THE INVENTION

The present invention was made in view of the above circumstances and aims to provide a magnetic unit that can properly realize a configuration for assembling the biasing member to the case.

To achieve the objection, a magnetic unit according to one aspect of the present invention includes a magnetic core formed in an annular shape about a first direction and including a first core and a second core split along a second direction that intersects with the first direction, in which the second core provided on one side in a third direction that intersects with the first direction and the second direction and the first core provided on the other side in the third direction are in contact with each other along the third direction; a base member that accommodates the magnetic core and includes a bottom part that supports the first core and a sidewall part that is provided on a side of the magnetic core in the second direction; and an biasing member with an end part in the second direction held by the sidewall part, the biasing member being configured to bias the second core to the other side in the third direction, wherein the sidewall part includes a biasing member holding part that is locked to the end part of the biasing member, the biasing member includes a biasing member side inclined contact surface formed with inclination to a surface on one side in the third direction, and the biasing member holding part includes a sidewall part side inclined contact surface formed with inclination so as to be in surface contact with the biasing member side inclined contact surface while the biasing member is in a biased state.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a magnetic unit according to a first embodiment;

FIG. 2 is an exploded perspective view illustrating the magnetic unit according to the first embodiment;

FIG. 3 is a perspective view of a base member according to the first embodiment;

FIG. 4 is a cross-sectional perspective view taken along IV-IV in FIG. 3;

FIG. 5 is a perspective view illustrating a bobbin according to the first embodiment;

FIG. 6 is a perspective view illustrating a plate spring according to the first embodiment;

FIG. 7 is a cross-sectional view taken along VII-VII in FIG. 1;

FIG. 8 is a perspective view illustrating a state before the plate spring is attached to the base member according to the first embodiment;

FIG. 9 is a perspective view illustrating a state in which the plate spring is mounted on a magnetic core accommodated in the base member according to the first embodiment;

FIG. 10 is a perspective view illustrating a state in which the plate spring is rotated in order to lock the plate spring to the base member according to the first embodiment;

FIG. 11 is a perspective view representing a magnetic unit according to a second embodiment;

FIG. 12 is a perspective view illustrating a plate spring according to the second embodiment;

FIG. 13 is a cross-sectional view taken along XIII-XIII in FIG. 11;

FIG. 14 is a perspective view illustrating a state in which a pinch part of the plate spring is pinched for compression before the plate spring is attached to the base member according to the second embodiment;

FIG. 15 is a cross-sectional view corresponding to a cross section taken along XIII-XIII in FIG. 11, illustrating a state in which the plate spring with the pinch part pinched for compression is mounted on the magnetic core;

FIG. 16 is a perspective view illustrating a magnetic unit according to a third embodiment;

FIG. 17 is a perspective view illustrating a base member according to the third embodiment;

FIG. 18 is a cross-sectional view taken along XVIII-XVIII in FIG. 17;

FIG. 19 is a perspective view illustrating a plate spring according to the third embodiment;

FIG. 20 is a cross-sectional view taken along XX-XX in FIG. 16;

FIG. 21 is a perspective view illustrating a state before the plate spring is attached to the base member according to the third embodiment;

FIG. 22 is a cross-sectional view corresponding to a cross section taken along XVIII-XVIII in FIG. 17, illustrating a state in which an inclined contact surface of the plate spring is inserted to a biasing member holding part; and

FIG. 23 is a perspective view illustrating an example of incorrect assembly of the plate spring according to the third embodiment.

### DETAILED DESCRIPTION OF THE PREFERRED EMBODIMENTS

Embodiments according to the present invention will hereinafter be described in detail on the basis of the drawings. Note that the present invention is not limited by the embodiments. In addition, the components in the following embodiments include those that are substitutable and easily conceivable for persons who are skilled in the art, or those that are substantially the same.

### First Embodiment

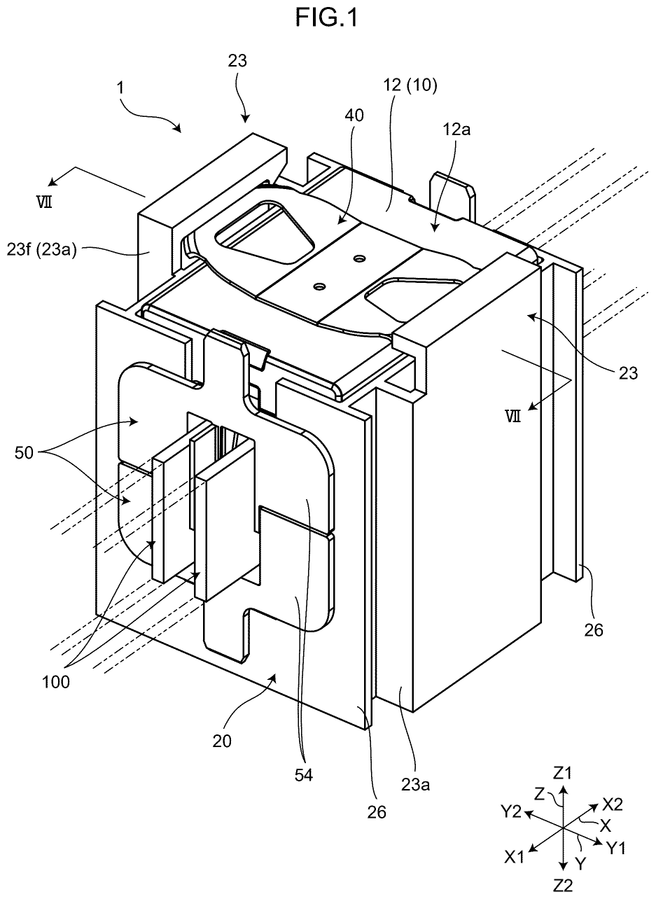

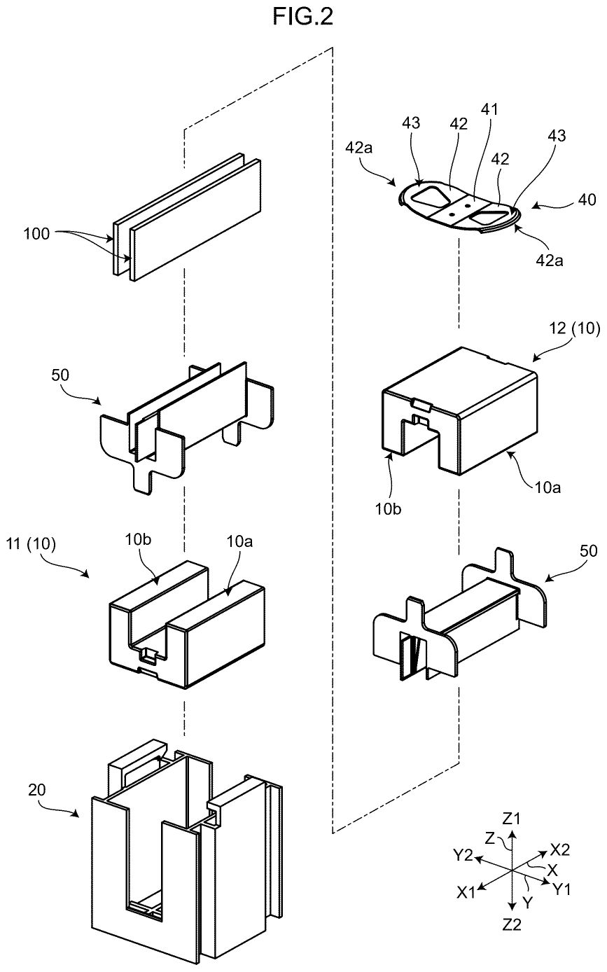

A first embodiment is described based on FIG. 1 to FIG. 10. A magnetic unit 1 according to the first embodiment illustrated in FIG. 1 and FIG. 2 is, for example, provided in a high-voltage junction box to which a high-voltage battery pack mounted in a vehicle, such as an electric vehicle or a hybrid vehicle, is electrically connected. In the magnetic unit 1, busbars 100 are inserted to a magnetic core 10 with an annular shape that includes split cores, that is, a first core 11 and a second core 12. The busbar 100 is a circuit body (conductor) that forms a high-voltage circuit system including a high-voltage battery pack and the like. The magnetic unit 1 including the magnetic core 10 can suitably remove high-frequency noise in the busbar 100 and suitably suppress surge voltages.

The magnetic unit 1 includes the magnetic core 10, a base member 20, a plate spring 40 as a biasing member, and two bobbins 50. Two busbars 100 are inserted to the magnetic core 10, which is formed in an annular shape. The busbar 100 is formed in a long shape, and is illustrated only partially in the drawing. The magnetic core 10 and the two bobbins 50 to which the busbars 100 are inserted are accommodated in the base member 20, which is a case.

In the following description, an axial direction of the annular magnetic core 10 in which the two busbars 100 extend is a first direction X, and two directions that are orthogonal to the first direction X are a second direction Y and a third direction Z. The second direction Y is the direction in which the two busbars 100 are arranged. One side in the first direction X is described as one side X1 and the other side is described as the other side X2 below. Similarly, one side and the other side in the second direction Y are described as one side Y1 and the other side Y2 and one side and the other side in the third direction Z are described as one side Z1 and the other side Z2, respectively.

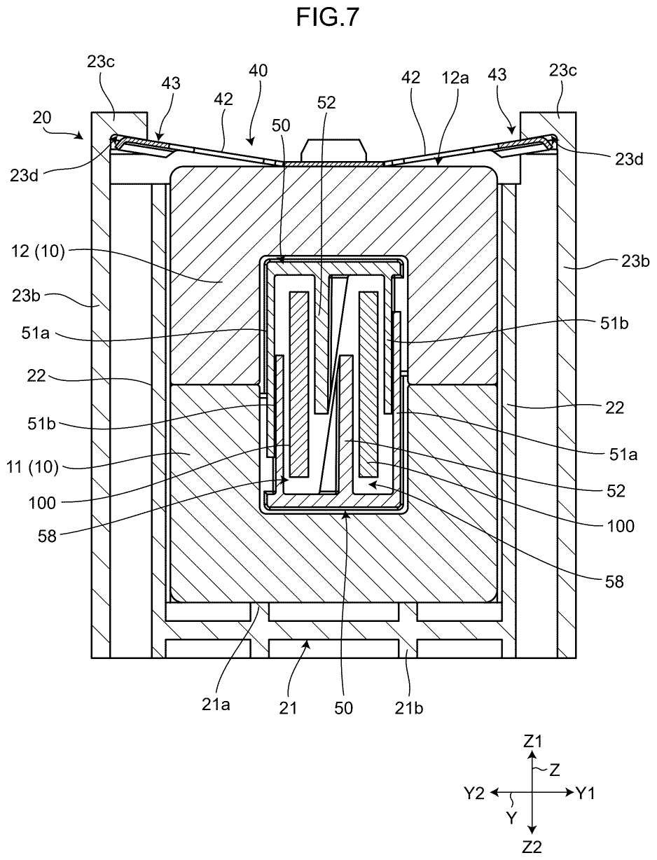

As illustrated in FIG. 2, the magnetic core 10 includes the first core 11 and the second core 12 split along the second direction Y. The first core 11 is provided on the other side Z2 in the third direction Z, and the second core 12 is provided on one side Z1 in the third direction Z. The magnetic core 10 is formed annularly about the first direction X with the first core 11 and the second core 12 combined (see also FIG. 7). The first core 11 and the second core 12 are formed in the same shape and are formed of a magnetic material such as ferrite. The first core 11 and the second core 12 have an approximately U-like shape as viewed from the first direction X, and are long along the first direction X. Of the first core 11 and the second core 12, two flat surfaces located on the open side of the approximately U-like shape are contact surfaces 10a and 10b. In the magnetic core 10, the respective contact surfaces 10a and 10b of the first core 11 and the second core 12 are in contact with each other along the third direction Z.

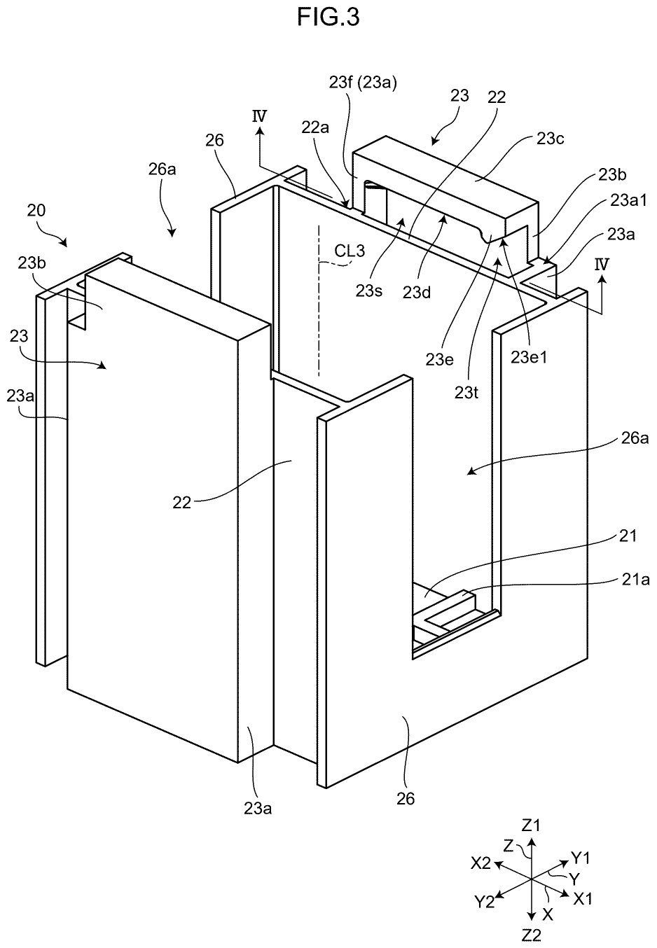

As illustrated in FIG. 3, the base member 20 is formed in an approximately cuboid box-like shape with an opening on one side Z1 in the third direction Z. The base member 20 has an approximately long rectangular plate-shaped bottom part 21 that is approximately parallel to a plane containing the first direction X and the second direction Y. On one side Z1 of the bottom part 21 in the third direction Z, a core support part 21a is formed in a grid pattern. A surface of the core support part 21a on one side Z1 in the third direction Z is in contact with, and supports the surface of the first core 11 on the other side Z2 in the third direction Z. As illustrated in FIG. 7, a rib 21b with the grid pattern similar to that of the core support part 21a is also formed at the bottom part 21 on the other side Z2 in the third direction Z.

At an end part of the bottom part 21 on one side Y1 in the second direction Y and an end part thereof on the other side Y2, two sidewall parts 22 rising toward one side Z1 in the third direction Z are provided. The sidewall part 22 has an approximately plate-like shape with a plate surface facing in the second direction Y. The sidewall parts 22 are each located on the side of the magnetic core 10 in the second direction Y (see FIG. 7). At each end part of each of the sidewall parts 22 on one side X1 and the other side X2 in the first direction X, an insertion plate part 26 with an approximately plate-like shape is provided. Each of the insertion plate parts 26 is provided with a plate surface facing in the first direction X. Each of the insertion plate parts 26 has an insertion opening 26a that is long along the third direction Z at a substantial center in the second direction Y. The bobbin 50 is disposed in the insertion opening 26a and the busbar 100 is inserted therethrough.

At each of the sidewall parts 22, a biasing member holding part 23 is provided. The biasing member holding part 23 is formed in an approximately box-like shape on the outside of the sidewall part 22. The biasing member holding part 23 projects to one side Z1 in the third direction Z1 compared to the end part of the sidewall part 22 on one side Z1 in the third direction Z. An opening 23s is provided on one side Z1 of the sidewall part 22 in the third direction Z inside the biasing member holding part 23. The biasing member holding part 23 on one side Y1 in the second direction Y and the biasing member holding part 23 on the other side Y2 are formed in point symmetry about an axial center CL3 of the base member 20 along the third direction Z. The biasing member holding part 23 on one side Y1 in the second direction Y will be described below and the detailed description of the biasing member holding part 23 on the other side Y2 will be omitted.

The biasing member holding part 23 has two side plates 23a with their plate surfaces facing in the first direction X, and the two side plates 23a are provided with a predetermined gap therebetween in the first direction X. The other side Y2 of the two side plates 23a in the second direction Y is connected to the sidewall part 22. Of the two side plates 23a, the side plate 23a on one side X1 in the first direction X has the same length in the third direction Z as the sidewall part 22. Therefore, an end surface 23a1 of the side plate 23a, which is on one side X1 in the first direction X, on one side Z1 in the third direction Z is continuous with an end surface 22a of the sidewall part 22 on one side Z1. Of the two side plates 23a, the side plate 23a on the other side X2 in the first direction X projects to one side Z1 compared to the end surface 22a of the sidewall part 22 on one side Z1 in the third direction Z.

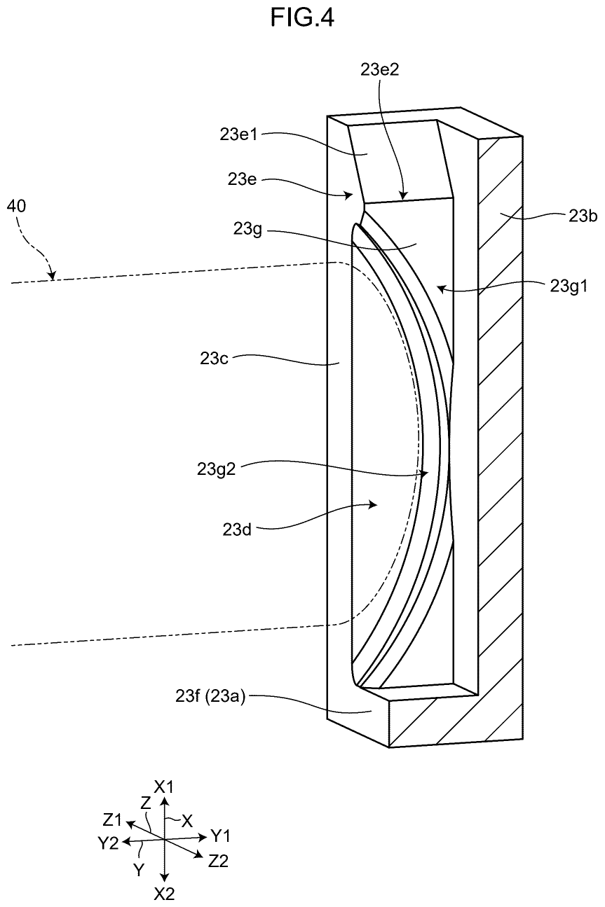

One side Y1 of the two side plates 23a in the second direction Y is connected to a support plate 23b. The support plate 23b is provided with its plate surface facing in the second direction Y. The support plate 23b has the same length in the third direction Z as the side plate 23a on the other side X2 in the first direction X. The support plate 23b and the side plate 23a on the other side X2 in the first direction X are each connected to a locking plate 23c on one side Z1 in the third direction Z. The locking plate 23c is provided with its plate surface facing in the third direction Z. The locking plate 23c is long along the first direction X. On the other side Z2 of the locking plate 23c in the third direction Z, a sidewall part side inclined contact surface 23d is provided (see FIG. 4 and FIG. 7). The sidewall part side inclined contact surface 23d is inclined from one side Z1 to the other side Z2 in the third direction Z along one side Y1 to the other side Y2 in the second direction Y (in other words, along the direction from the outside to the inside of the sidewall part 22).

The biasing member holding part 23 includes a mountain-shaped projection 23e with a mountain shape on one side X1 of the sidewall part side inclined contact surface 23d provided along the first direction X, and a regulatory wall part 23f on the other side X2 of the sidewall part side inclined contact surface 23d. The regulatory wall part 23f is a part of the side plate 23a on the other side X2 in the first direction X that projects to one side Z1 from the end surface 22a of the sidewall part 22 on one side Z1 in the third direction Z, and corresponds to a part of the side plate 23a on the other side X2 in the first direction X. The mountain-shaped projection 23e projects in a mountain shape from the locking plate 23c toward the other side Z2 in the third direction Z at an end part of the locking plate 23c on one side X1 in the first direction X. A surface of the mountain-shaped projection 23e on one side X1 in the first direction X is an inclined surface 23e1 that is inclined from one side Z1 to the other side Z2 in the third direction Z along one side X1 to the other side X2 in the first direction X. The other side Z2 in the third direction Z at a projecting end 23e2 of the mountain-shaped projection 23e is an insertion port 23t separated from the end surface 22a of the sidewall part 22 on one side Z1. The insertion port 23t communicates with the internal space of the biasing member holding part 23.

As illustrated in FIG. 4, an arc-shaped swelling part 23g is provided on the other side Z2 of the locking plate 23c in the third direction Z. The arc-shaped swelling part 23g swells from the locking plate 23c toward the other side Z2 in the third direction Z so as to surround, in an arc-like shape, the sidewall part side inclined contact surface 23d. The arc-shaped swelling part 23g is connected to each of the mountain-shaped projection 23e, the regulatory wall part 23f, and the support plate 23b. The sidewall part side inclined contact surface 23d is formed in an arc-like shape as viewed from the other side Z2 in the third direction Z by being surrounded by the arc-shaped swelling part 23g. A surface 23g1 of the arc-shaped swelling part 23g on the other side Z2 in the third direction Z is continuous with the projecting end 23e2 of the mountain-shaped projection 23e.

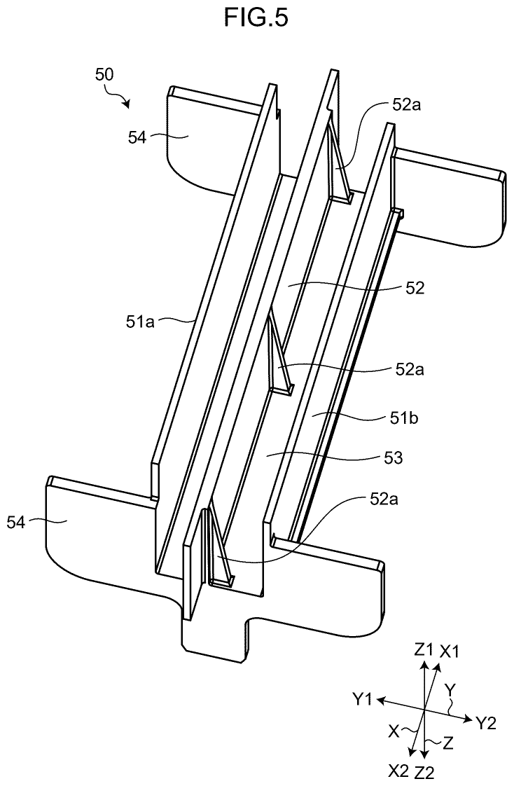

As illustrated in FIG. 2, the two bobbins 50 are provided facing each other along the third direction Z. Note that the two bobbins 50 are identical in shape. As illustrated in FIG. 5, the bobbin 50 includes two side plates 51a and 51b provided apart from each other, and a partition plate 52 provided between the two side plates 51a and 51b. Each of the side plates 51a and 51b and the partition plate 52 is formed in an approximately long rectangular shape that is long in the first direction X and has its plate surface facing in the second direction Y. Each of the side plates 51a and 51b and the partition plate 52 is connected by a bottom plate 53 at the end part in the third direction Z (the end part on the other side Z2 in FIG. 5). The height, in the third direction Z, of the side plate 51a on one side Y1 in the second direction Y as illustrated in FIG. 5 is higher than that of the side plate 51b on the other side Y2 and the partition plate 52. On the other side Y2 of the partition plate 52 in the second direction Y, three ribs 52a that connect to the bottom plate 53 are provided. In each of the side plates 51a and 51b, a stop plate 54 is provided at each of end parts on one side X1 and the other side X2 in the first direction X. The stop plate 54 is provided with its plate surface facing in the first direction X. The stop plate 54 has an opening corresponding to the space between the side plates 51a and 51b and includes a part projecting to the outside of the side plates 51a and 51b.

The two bobbins 50 facing each other in the third direction Z are disposed inside the annular shape of the magnetic core 10, and busbar insertion paths 58 are formed on one side Y1 and the other side Y2 of the partition plates 52 in the second direction Y (see FIG. 7). Note that the partition plates 52 overlap with each other near the end part in the third direction Z. An inner side surface of the stop plate 54 of each bobbin 50 is close to, or in contact with an outer side surface of the insertion plate part 26 of the base member 20 (see FIG. 1).

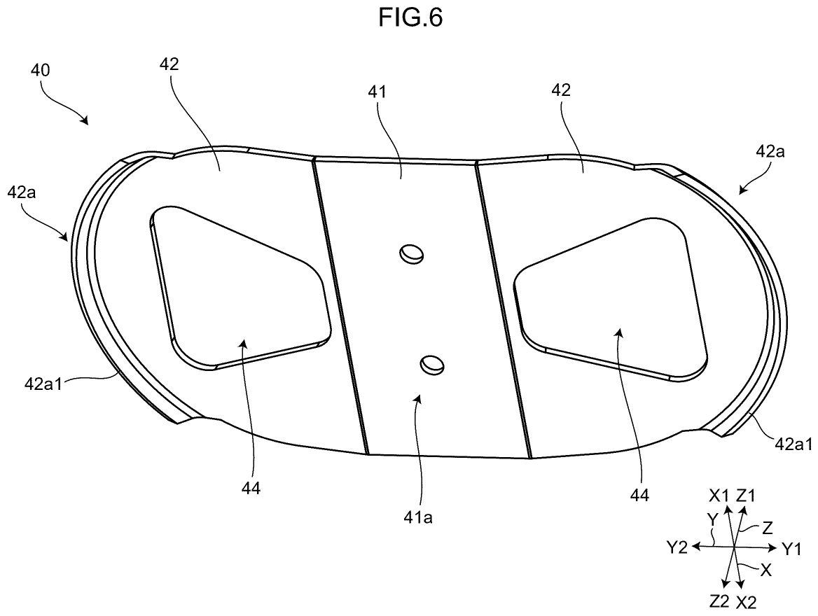

As illustrated in FIG. 6, the plate spring 40 is formed in the approximately long rectangular plate-like shape whose longitudinal direction corresponds to the second direction Y. The plate spring 40 is formed of a sheet metal material and is formed in an approximately concave shape in the side view viewed from the first direction X. A central part of the plate spring 40 in the second direction Y is a biasing contact part 41 to be in contact with the second core 12. The biasing contact part 41 is formed in an approximately flat-plate shape with an approximately long rectangular shape that is long in the first direction X. On each of one side Y1 and the other side Y2 of the biasing contact part 41 in the second direction Y, an inclined contact part 42 is provided. Each inclined contact part 42 is bent and formed on one side Z1 in the third direction Z so as to be inclined with respect to the biasing contact part 41. That is to say, the inclined contact part 42 is formed so as to be inclined from one side Z1 to the other side Z2 in the third direction Z from each end part 42a of the plate spring 40 on one side Y1 and the other side Y2 toward the biasing contact part 41 along the second direction Y. A surface on one side Z1 in the third direction Z in the vicinity of the end part 42a in each inclined contact part 42 is a biasing member side inclined contact surface 43. The biasing member side inclined contact surface 43 is formed, similar to the inclined contact part 42, so as to be inclined from one side Z1 to the other side Z2 in the third direction Z from the end part 42a of the inclined contact part 42 toward the biasing contact part 41 along the second direction Y. An edge of the end part 42a of each inclined contact part 42 is formed in an arc-like shape as viewed from the third direction Z, and additionally, a bent part 42a1 that is obtained by bending the edge of the end part 42a in the direction of the other side Z2 in the approximately third direction Z is formed. The bent part 42a1 is formed in an arc-like shape as viewed from the third direction Z, following the edge of the end part 42a. Each inclined contact part 42 has a penetration hole part 44 that opens through with an approximately triangular shape.

As illustrated in FIG. 7, when the plate spring 40 is assembled to the base member 20, a surface 41a of the biasing contact part 41 of the plate spring 40 on the other side Z2 in the third direction Z is in contact with a surface 12a of the second core 12 on one side Z1. The biasing member side inclined contact surfaces 43 of the plate spring 40 provided at both ends along the second direction Y are in contact (surface contact) with the sidewall part side inclined contact surfaces 23d of the biasing member holding parts 23 on one side Y1 and the other side Y2 in the second direction Y. In other words, the sidewall part side inclined contact surface 23d is formed with inclination so as to be in surface contact with the biasing member side inclined contact surface 43.

As the end parts 42a of the plate spring 40 on both sides in the second direction Y are held by the biasing member holding parts 23 of the sidewall parts 22, these end parts 42a on both sides are held in a state of having shifted from the steady state to the other side Z2 in the third direction Z against the biasing force of the inclined contact parts 42 of the plate spring 40. In other words, the plate spring 40 is held in the biased state. On the other hand, the first core 11 is supported by the core support part 21a at the bottom part 21 of the base member 20. Therefore, the plate spring 40 biases the second core 12 toward the other side Z2 in the third direction Z (that is, the first core 11) by the biasing force of the inclined contact part 42.

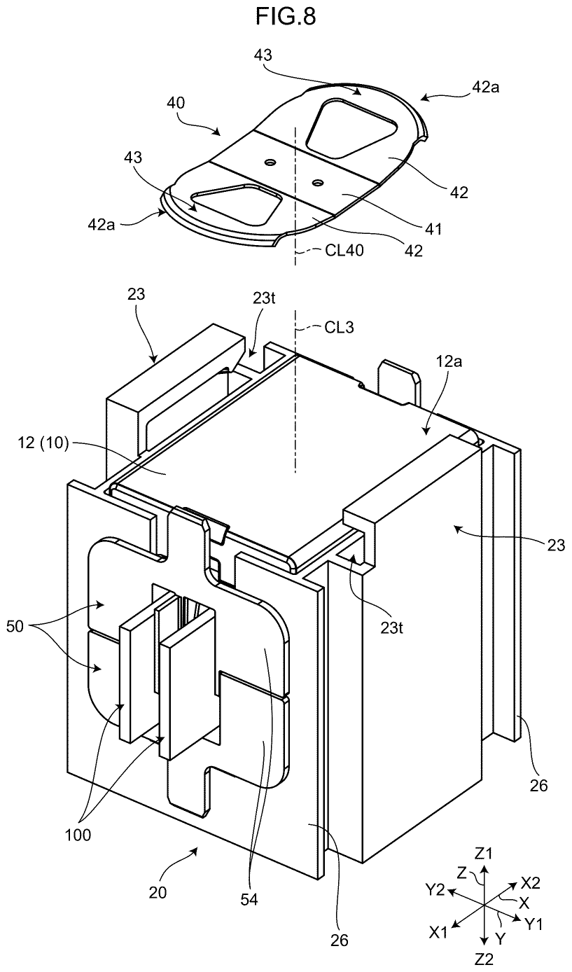

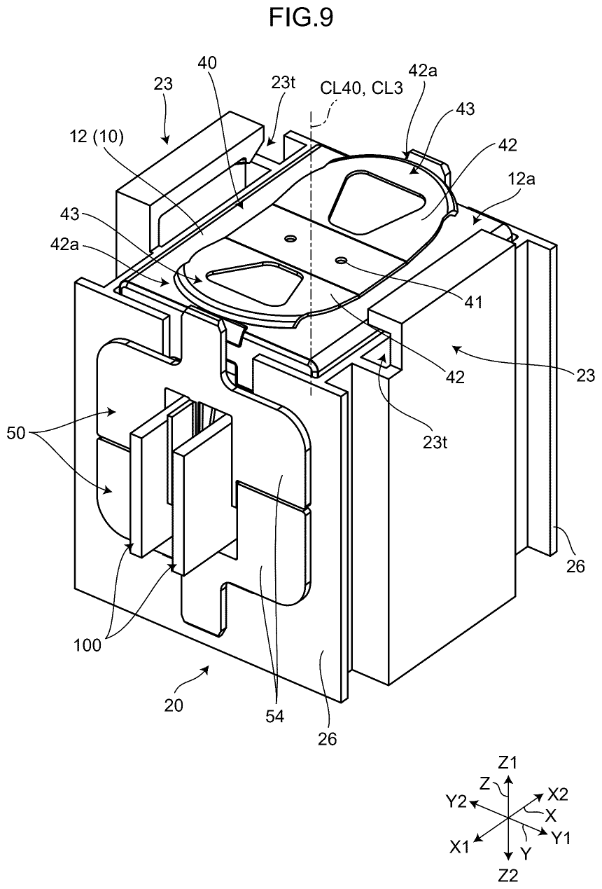

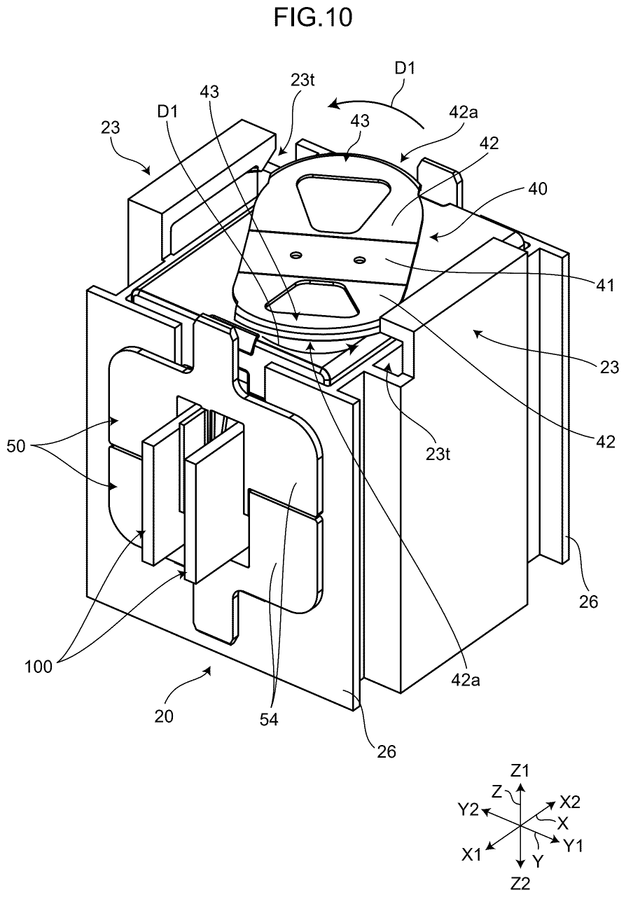

The plate spring 40 is assembled as follows. First, as illustrated in FIG. 8, the plate spring 40 is mounted on the second core 12 from one side Z1 in the third direction Z with respect to the base member 20 that accommodates the magnetic core 10 and the two bobbins 50 with the busbars 100 inserted thereto. At this time, the plate spring 40 is oriented so that its longitudinal direction (that is, the end part 42a of the plate spring 40) extends along the first direction X. The surface 41a of the biasing contact part 41 of the plate spring 40 on the other side Z2 in the third direction Z faces the other side Z2. The plate spring 40 is mounted on the second core 12 so that the axial center CL3 of the base member 20 along the third direction Z substantially coincides with an axial center CL40 of the plate spring 40 along the third direction Z as illustrated in FIG. 9. When the plate spring 40 is mounted on the second core 12, the surface 41a of the biasing contact part 41 of the plate spring 40 on the other side Z2 in the third direction Z comes into contact with the surface 12a of the second core 12 on one side Z1 in the third direction Z. Then, as illustrated in FIG. 10, the end part 42a of the plate spring 40 is rotated about the axial center CL40 (axial center CL3) as indicated by an arrow D1 toward the mountain-shaped projection 23e (insertion port 23t) of the biasing member holding part 23. Then, the biasing member side inclined contact surface 43 of the plate spring 40 is in sliding contact with the inclined surface 23e1 of the mountain-shaped projection 23e (see FIG. 4), and the inclined contact part 42 is bent to the other side Z2 in the third direction Z. The inclined contact part 42 (biasing member side inclined contact surface 43) of the plate spring 40 is disposed on the sidewall part side inclined contact surface 23d, which is depressed from the arc-shaped swelling part 23g, through the arc-shaped swelling part 23g from the projecting end 23e2 of the mountain-shaped projection 23e (see FIG. 4). At this time, the sidewall part side inclined contact surface 23d is in contact (surface contact) with the biasing member side inclined contact surface 43, resulting in the state illustrated in FIG. 7. As illustrated in FIG. 4, the sidewall part side inclined contact surface 23d is connected to the arc-shaped swelling part 23g through a step part 23g2, so that the rotation of the plate spring 40 about the axial center CL40 is regulated. When the plate spring 40 is assembled, an edge part of the plate spring 40 comes into contact with the regulatory wall part 23f if the plate spring 40 is rotated to the opposite side of the arrow D1 in FIG. 10. This regulates the attaching direction of the plate spring 40.

### Second Embodiment

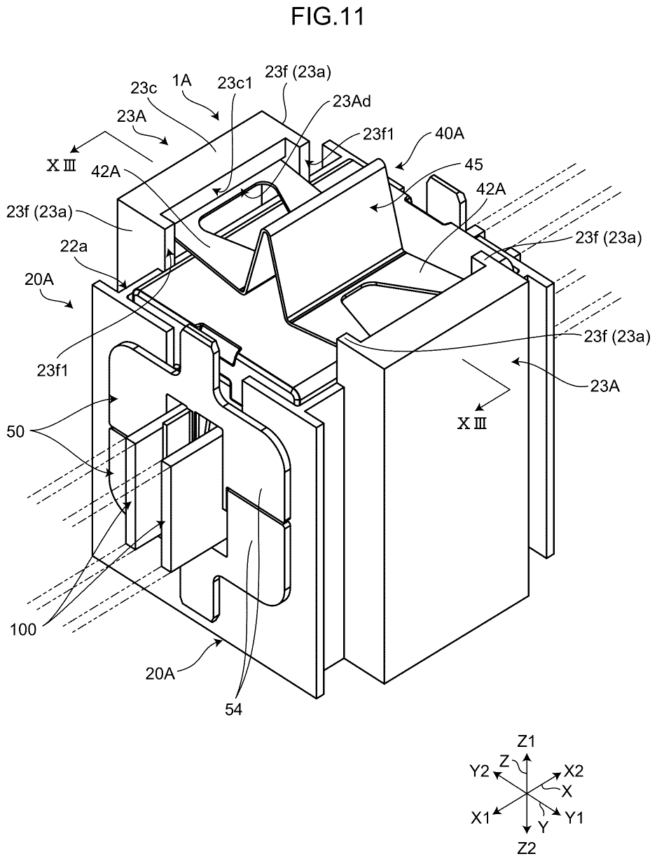

Next, a second embodiment is described based on FIG. 11 to FIG. 15. As illustrated in FIG. 11, a magnetic unit 1A according to this embodiment includes a plate spring 40A with a mountain-shaped pinch part 45 at a central part instead of the plate spring 40 in the first embodiment. The magnetic unit 1A according to this embodiment includes a base member 20A equipped with biasing member holding parts 23A including the regulatory wall parts 23f at both ends along the first direction X, instead of the base member 20 equipped with the biasing member holding parts 23 in the first embodiment. Hereinafter, the same components and the same parts as those in the first embodiment will be denoted with the same symbols, and the description thereof will be omitted or simplified.

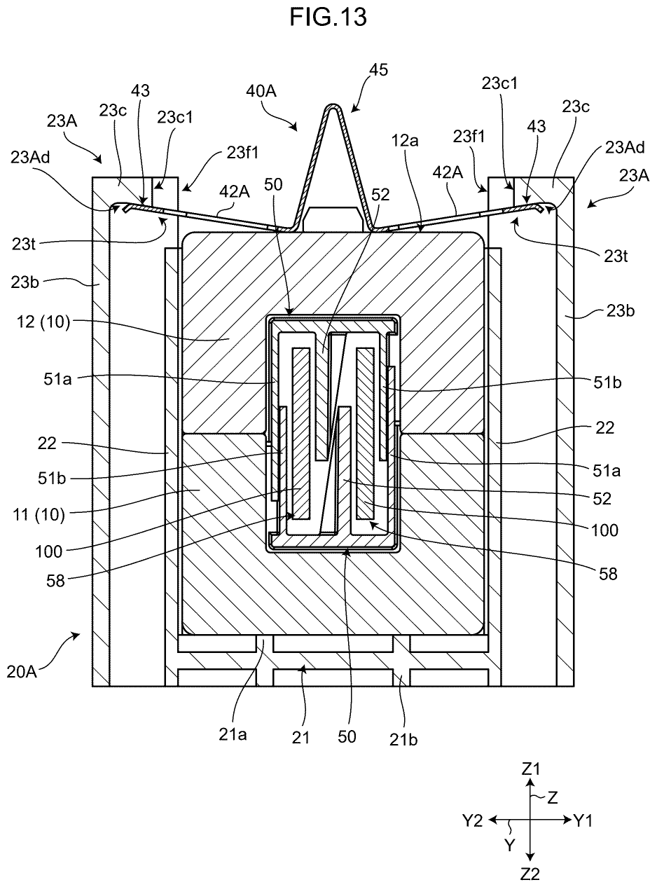

The biasing member holding part 23A includes a sidewall part side inclined contact surface 23Ad that is long along the first direction X (see FIG. 13). The sidewall part side inclined contact surface 23Ad is formed so as to be inclined from one side Z1 to the other side Z2 in the third direction Z along the direction from the outside to the inside of the sidewall part 22. In the biasing member holding part 23A, the regulatory wall parts 23f are provided on one side X1 and the other side X2 in the first direction X in the sidewall part side inclined contact surface 23Ad (that is, at both ends of the sidewall part side inclined contact surface 23Ad). Therefore, the internal space of the biasing member holding part 23A is closed on the outside of the biasing member holding part 23A and in the direction along the first direction X. The biasing member holding part 23A is open on one side Z1 relative to the end surface 22a of the sidewall part 22 on one side Z1 in the third direction Z and this opening corresponds to the insertion port 23t. An inner end surface 23f1 of the regulatory wall part 23f in this embodiment is located on the same plane as the inner side surface of the sidewall part 22 and is continuous (see also FIG. 13). Thus, the inner end surface 23f1 of the regulatory wall part 23f projects inwardly relative to an inner end surface 23c1 of the locking plate 23c.

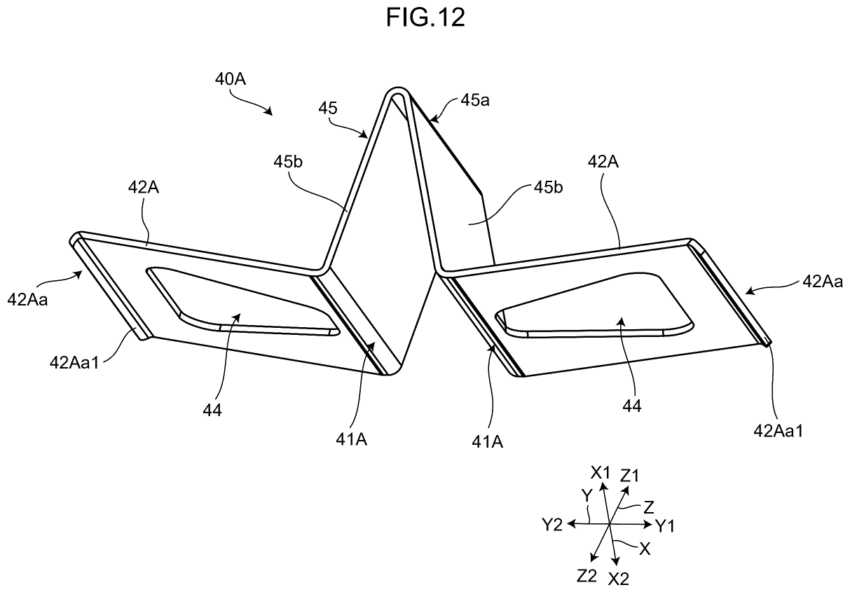

As illustrated in FIG. 12, the plate spring 40A is formed of a sheet metal material, with a central part along the second direction Y formed in a mountain shape. In other words, in the plate spring 40A, a bent part 45a is formed on one side Z1 in the third direction Z at an approximately central position along the second direction Y and the pinch part 45 that is bent into a mountain shape is provided. The pinch part 45 includes mountain-shaped plate parts 45b that are bent at the bent part 45a and are disposed opposite to each other along the second direction Y. The plate spring 40A includes two inclined contact parts 42A. Each inclined contact part 42A is provided to be inclined toward one side Z1 along the second direction Y from the other side Z2 of each mountain-shaped plate part 45b of the pinch part 45 in the third direction Z. The part where each inclined contact part 42A is bent and connected to each mountain-shaped plate part 45b corresponds to a biasing contact part 41A. Each inclined contact part 42A is formed in an approximately long rectangular shape. An end part 42Aa of each inclined contact part 42A is formed in an approximately straight line shape along the first direction X and corresponds to a bent part 42Aa1 that is bent in the direction of the other side Z2 in the approximately third direction Z. A surface of each inclined contact part 42A on one side Z1 in the third direction Z in the vicinity of the end part 42Aa of each inclined contact part 42A corresponds to the biasing member side inclined contact surface 43. The inclined contact part 42A is formed so as to be inclined from one side Z1 to the other side Z2 in the third direction Z from each end part 42Aa of the plate spring 40A on one side Y1 and the other side Y2 toward the biasing contact part 41A along the second direction Y. The biasing member side inclined contact surface 43 is formed, similar to the inclined contact part 42A, so as to be inclined from one side Z1 to the other side Z2 in the third direction Z from the end part 42Aa of the inclined contact part 42A toward the biasing contact part 41A along the second direction Y.

As illustrated in FIG. 13, when the plate spring 40A is assembled to the base member 20, each of the biasing contact parts 41A of the plate spring 40A is in contact with the surface 12a of the second core 12 on one side Z1. Each of the biasing member side inclined contact surfaces 43 on both sides of the plate spring 40A in the second direction Y is in contact (surface contact) with the sidewall part side inclined contact surface 23Ad of the biasing member holding part 23. In other words, each inclined contact part 42A where the biasing member side inclined contact surface 43 is provided extends with inclination from the biasing contact part 41A toward the biasing member holding part 23A located on one side Z1 in the third direction Z with respect to the biasing contact part 41A. The sidewall part side inclined contact surface 23Ad is formed with inclination so as to come into contact (surface contact) with the biasing member side inclined contact surface 43.

The end parts 42Aa of the plate spring 40A on both sides in the second direction Y are held in the biasing member holding parts 23A of the sidewall parts 22; thus, these end parts 42Aa on both sides are held in a state of having shifted from the steady state to the other side Z2 in the third direction Z against the biasing force of the inclined contact parts 42A of the plate spring 40A. In other words, the plate spring 40A is held in the biased state. On the other hand, the first core 11 is supported by the core support part 21a at the bottom part 21 of the base member 20. Therefore, the plate spring 40A biases the second core 12 toward the other side Z2 in the third direction Z (that is, the first core 11) by the biasing force of the inclined contact part 42A.

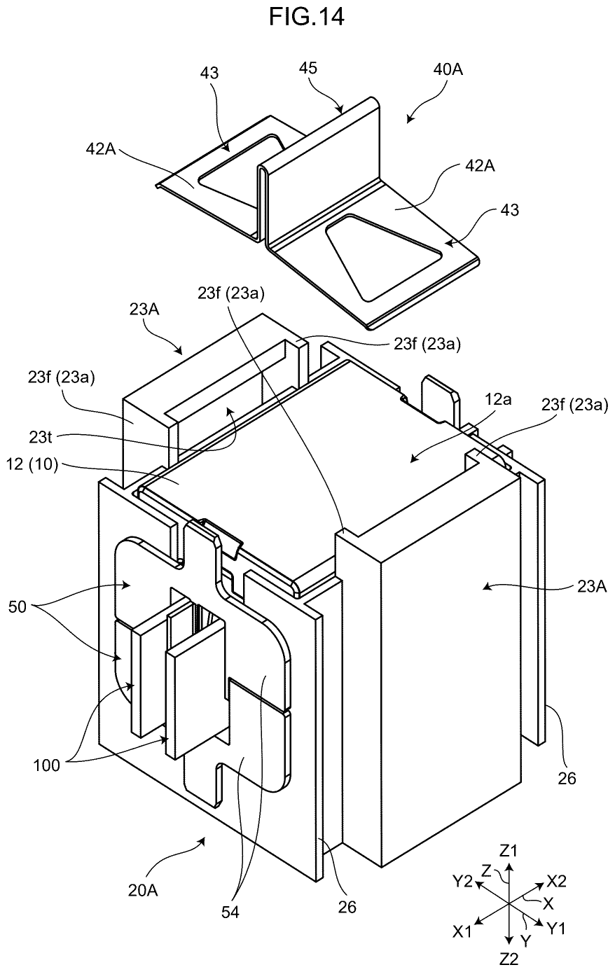

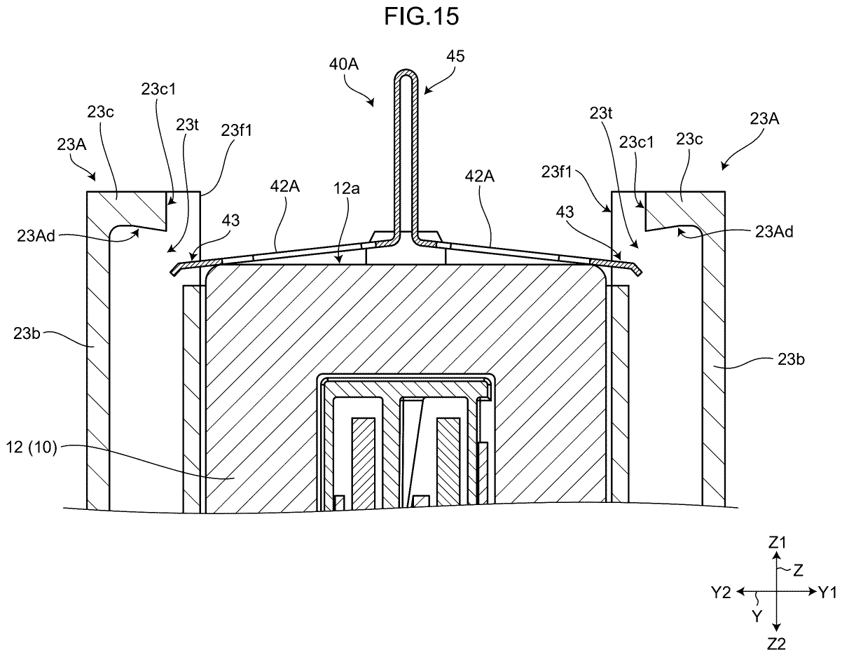

The plate spring 40A is assembled as follows. First, as illustrated in FIG. 14, the plate spring 40A is mounted on the second core 12 from one side Z1 in the third direction Z with respect to the base member 20 that accommodates the magnetic core 10 and the two bobbins 50 with the busbars 100 inserted thereto. At this time, the plate spring 40A is oriented so that its longitudinal direction (that is, the end part 42Aa of the plate spring 40A) extends along the second direction Y. The biasing contact parts 41A of the plate spring 40A are placed on the other side Z2 in the third direction Z, and by pinching the pinch part 45, the biasing contact parts 41A are made close to each other so as to close the two mountain-shaped plate parts 45b against the biasing force in the direction where the two mountain-shaped plate parts 45b are separated from each other. As illustrated in FIG. 15, the plate spring 40A is placed on the second core 12 so that the biasing member side inclined contact surface 43 of the plate spring 40A comes to the position corresponding to the insertion port 23t of the biasing member holding part 23A. After that, when the fingers are released from the pinch part 45 of the plate spring 40A, the mountain-shaped plate parts 45b are separated by a restoring force, and the biasing member side inclined contact surface 43 comes into contact (surface contact) with the sidewall part side inclined contact surface 23Ad; thus, the state in FIG. 13 is obtained.

### Third Embodiment

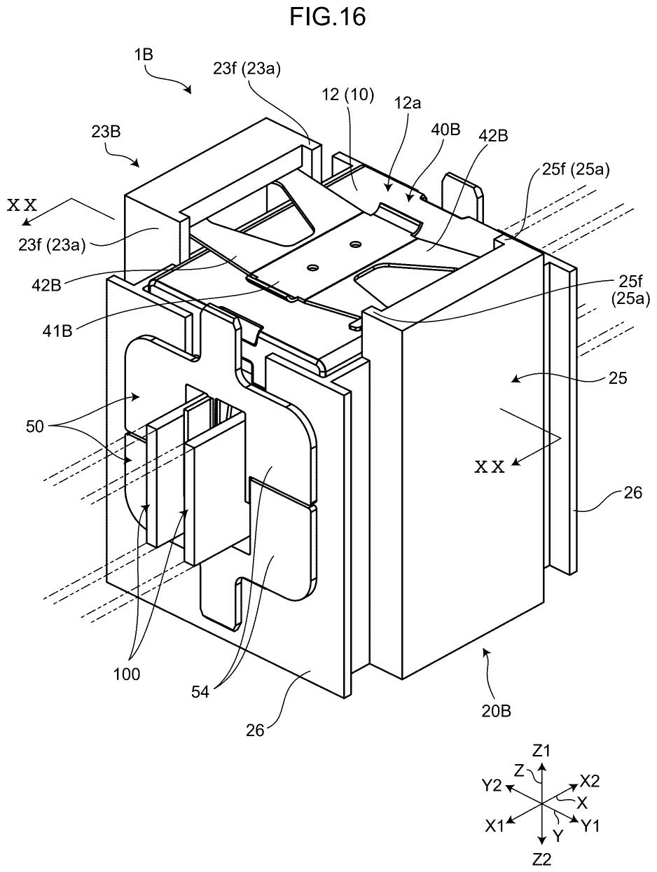

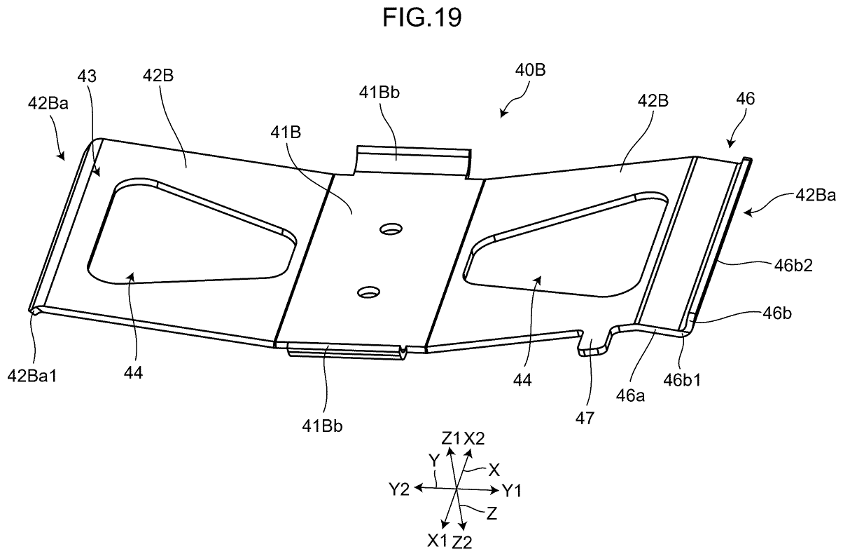

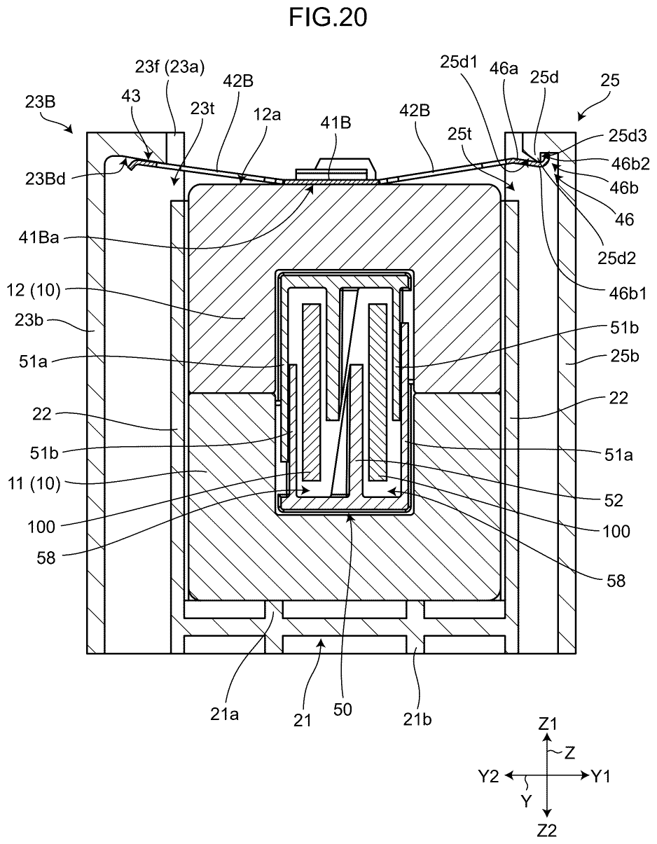

Next, a third embodiment is described based on FIG. 16 to FIG. 23. As illustrated in FIG. 16, a magnetic unit 1B according to this embodiment includes a plate spring 40B instead of the plate spring 40 in the first embodiment. The plate spring 40B includes the biasing member side inclined contact surface 43 in one inclined contact part 42B and a bent end part 46 (see FIG. 19) in the other inclined contact part 42B. The magnetic unit 1B according to this embodiment includes a base member 20B instead of the base member 20 including the biasing member holding part 23 in the first embodiment. The base member 20B is equipped with a biasing member holding part 23B including the regulatory wall parts 23f at both ends along the first direction X and a biasing member locking part 25 (see FIG. 20) that locks to the bent end part 46 of the plate spring 40B. Hereinafter, the same components and the same parts as those in the first embodiment will be denoted with the same symbols, and the description thereof will be omitted or simplified.

The sidewall part 22 of the base member 20B on one side Y1 in the second direction Y includes the biasing member locking part 25. The sidewall part 22 of the base member 20B on the other side Y2 in the second direction Y includes the biasing member holding part 23B. The biasing member holding part 23B has the same configuration as the biasing member holding part 23A in the second embodiment. In other words, the biasing member holding part 23B includes a sidewall part side inclined contact surface 23Bd that is long along the first direction X (see FIG. 20), and the regulatory wall parts 23f are provided at both ends of the sidewall part side inclined contact surface 23Bd along the first direction X. The sidewall part side inclined contact surface 23Bd is formed so as to be inclined from one side Z1 to the other side Z2 in the third direction Z along the direction from the outside to the inside of the sidewall part 22.

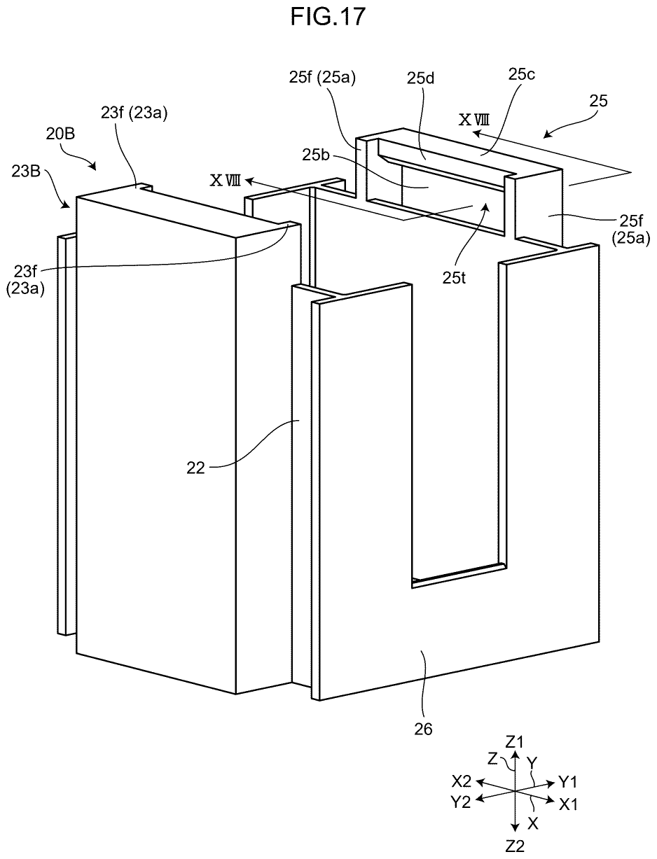

The biasing member locking part 25 is formed in an approximately box-like shape on the outside of the sidewall part 22. As illustrated in FIG. 17, the biasing member locking part 25 projects to one side Z1 in the third direction Z compared to the end surface 22a of the sidewall part 22 on one side Z1 in the third direction Z. The biasing member locking part 25 of the sidewall part 22 on one side Z1 in the third direction Z includes an insertion port 25t that opens inward.

The biasing member locking part 25 has two side plates 25a provided with their plate surfaces facing in the first direction X while being separated from each other by a predetermined distance in the first direction X. The other side Y2 of the two side plates 25a in the second direction Y is connected to the side wall part 22. One side Y1 of the two side plates 25a in the second direction Y is connected to a support plate 25b. The support plate 25b is provided with its plate surface facing in the second direction Y. The length of the support plate 25b in the third direction Z is the same as the length of the side plate 25a in the third direction Z. The support plate 25b and the two side plates 25a are each connected to a locking plate 25c on one side Z1 in the third direction Z. The locking plate 25c is provided with its plate surface facing in the third direction Z. The locking plate 25c is long along the first direction X. A part of the side plate 25a that projects to one side Z1 relative to the end surface 22a of the sidewall part 22 on one side Z1 in the third direction Z also serves as a regulatory wall part 25f.

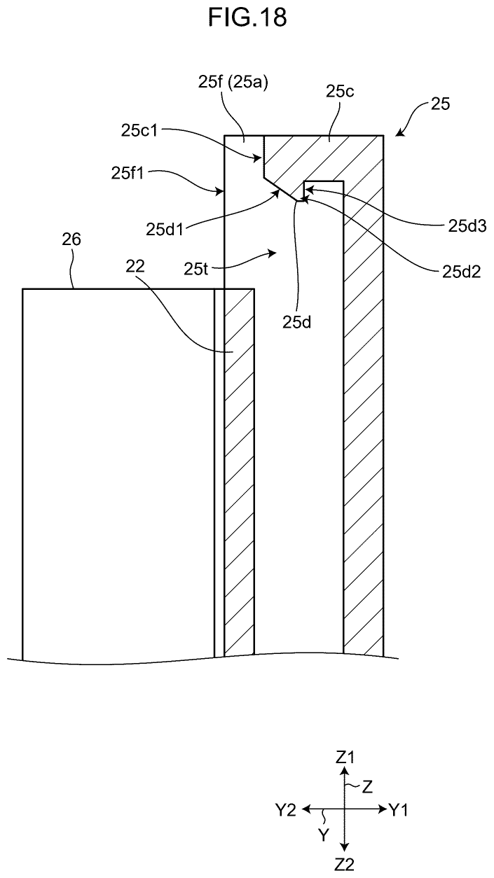

As illustrated in FIG. 17 and FIG. 18, a locking projection 25d that projects toward the other side Z2 is provided on the other side Z2 of the locking plate 25c in the third direction Z. To the locking projection 25d, the bent end part 46 of the plate spring 40B is locked. The locking projection 25d is provided at an edge of the locking plate 25c on the other side Y2 in the second direction Y. The locking projection 25d is provided in a long shape along the first direction X so as to be connected to each of the two side plates 25a (regulatory wall part 25f). In other words, the regulatory wall parts 25f are provided at both ends of the locking projection 25d along the first direction. As illustrated in FIG. 18, the locking projection 25d has a guide inclined surface 25d1 that is inclined on the magnetic core 10 side. The guide inclined surface 25d1 is inclined from one side Z1 to the other side Z2 in the third direction Z along one side Y1 from the other side Y2 in the second direction Y (in other words, from the inside to the outside of the biasing member locking part 25). The other side Y2 of the guide inclined surface 25d1 in the second direction Y is connected to an end surface 25c1 of the locking plate 25c on the other side Y2 in the second direction Y. One side Y1 of the guide inclined surface 25d1 in the second direction Y is connected to a jaw surface 25d3 through a projecting end 25d2 of the locking projection 25d. The jaw surface 25d3 is formed as a plane parallel to a plane containing the first direction X and the third direction Z. Note that an end surface 25f1 of the regulatory wall part 25f is continuously provided on the same plane as the inner side surface of the sidewall part 22. Therefore, the end surface 25f1 of the regulatory wall part 25f projects to the inside, that is, to the other side Y2 in the second direction Y, relative to the end surface 25c1 of the locking plate 25c.

As illustrated in FIG. 19, the plate spring 40B is formed in the approximately long rectangular plate-like shape whose longitudinal direction corresponds to the second direction Y. The plate spring 40B is formed in an approximately concave shape using a sheet metal material. A central part of the plate spring 40B in the second direction Y is formed in an approximately flat-plate shape and corresponds to a biasing contact part 41B that is in contact with the second core 12. The biasing contact part 41B is formed in the approximately long rectangular shape that is long in the first direction X. At each of end parts of the biasing contact part 41B on one side X1 and the other side X2 in the first direction X, a bent part 41Bb that is bent toward one side Z1 in the third direction Z is provided. At each of one side Y1 and the other side Y2 of the biasing contact part 41B in the second direction Y, the inclined contact part 42B is provided. Each inclined contact part 42B is formed by a bending process to form an inclination from the biasing contact part 41B toward one side Z1 in the third direction Z. That is to say, the inclined contact part 42B is formed so as to be inclined from one side Z1 to the other side Z2 in the third direction Z from each end part 42a of the plate spring 40B on one side Y1 and the other side Y2 toward the biasing contact part 41B along the second direction Y.

An end part 42Ba of each inclined contact part 42B is formed in a straight line shape along the first direction X. At the end part 42Ba of the inclined contact part 42B on one side Y1 in the second direction Y, the bent end part 46 is formed. The bent end part 46 includes a bent base part 46a that is bent a little toward the other side Z2 in the third direction Z with respect to the inclination direction of the inclined contact part 42B, and a bent locking part 46b that is bent from the bent base part 46a to one side Z1 in the third direction Z. The bent locking part 46b includes a bent part 46b1 connecting to the bent base part 46a and a rising part 46b2 rising from the bent part 46b1 to one side Z1 in the approximately third direction Z.

The inclined contact part 42B on one side Y1 in the second direction Y includes an attachment regulatory plate part 47 that projects in a flat plate shape from an edge on one side X1 in the first direction X in the vicinity of the bent base part 46a of the bent end part 46.

At an edge of the end part 42Ba of the inclined contact part 42B on the other side Y2 in the second direction Y, a bent part 42Ba1 that is bent to the other side Z2 in the approximately third direction Z is provided. The surface that is on the biasing contact part 41B side relative to the bent part 42Ba1 and on one side Z1 in the third direction Z at the inclined contact part 42B on the other side Y2 in the second direction Y corresponds to the biasing member side inclined contact surface 43.

As illustrated in FIG. 20, when the plate spring 40B is assembled to the base member 20B, a surface 41Ba of the biasing contact part 41B of the plate spring 40B on the other side Z2 in the third direction Z is in contact with the surface 12a of the second core 12 on one side Z1. The bent end part 46 of the plate spring 40B is locked with the locking projection 25d of the biasing member locking part 25. More specifically, the projecting end 25d2 of the locking projection 25d comes into contact with the bent part 46b1 of the bent locking part 46b of the bent end part 46, and the rising part 46b2 of the bent locking part 46b faces the jaw surface 25d3 of the locking projection 25d in the second direction Y. The biasing member side inclined contact surface 43 of the plate spring 40B is in contact (surface contact) with the sidewall part side inclined contact surface 23Bd of the biasing member holding part 23B. In this way, both ends of the plate spring 40B in the second direction Y are held, so that the end parts 42Ba of the inclined contact parts 42B at two positions facing each other along the second direction Y are held in a state of having shifted from the steady state to the other side Z2 in the third direction Z against the biasing force of the inclined contact parts 42B of the plate spring 40B. In other words, the plate spring 40B is held in the biased state. On the other hand, the first core 11 is supported by the core support part 21a at the bottom part 21 of the base member 20B. Therefore, the plate spring 40B biases the second core 12 to the other side Z2 in the third direction Z (that is, the first core 11).

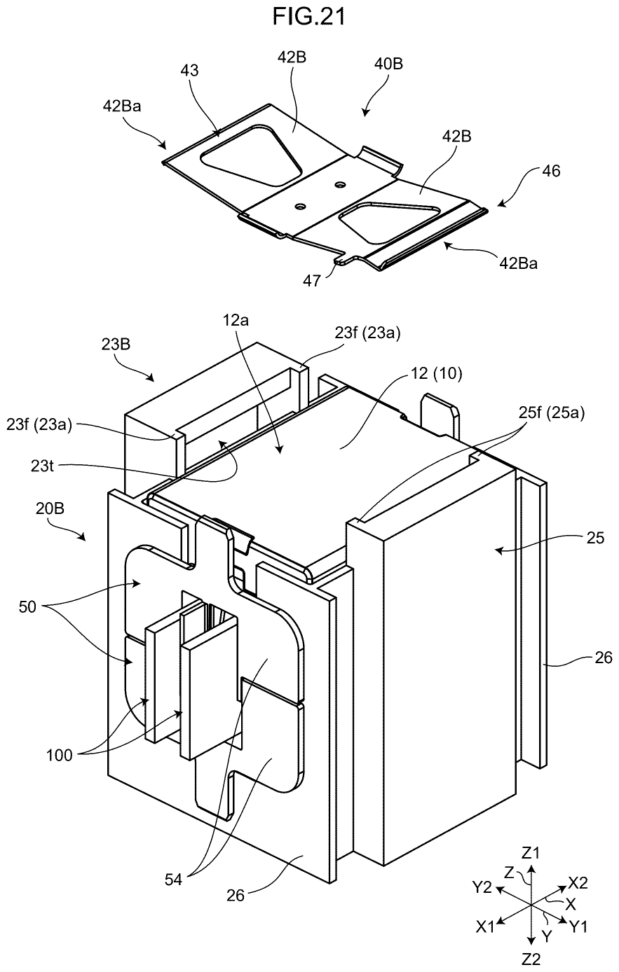

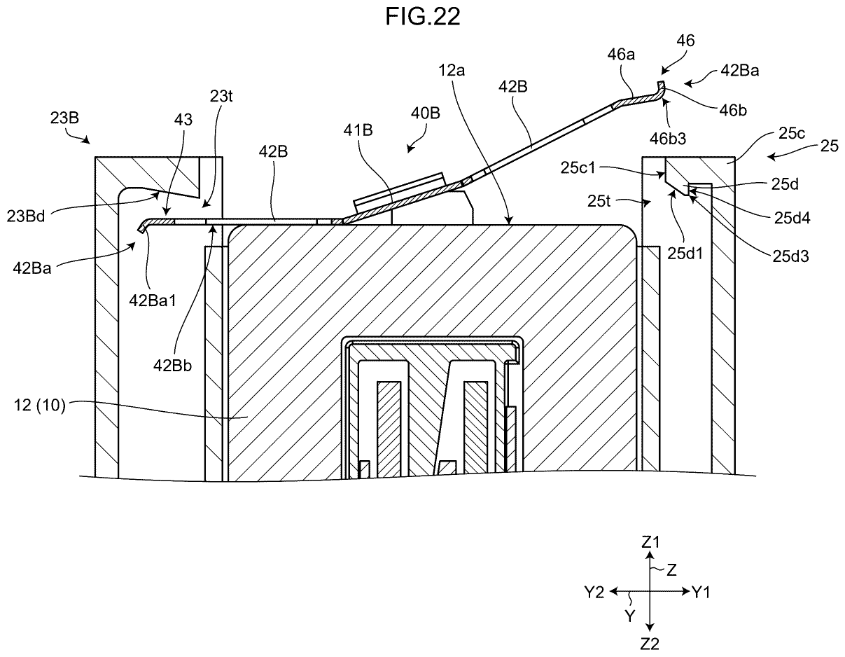

The plate spring 40B is assembled as follows. First, as illustrated in FIG. 21, the plate spring 40B is mounted on the second core 12 from one side Z1 in the third direction Z with respect to the base member 20B that accommodates the magnetic core 10 and the two bobbins 50 with the busbars 100 inserted thereto. At this time, the plate spring 40B is oriented so that the longitudinal direction (that is, the end part 42Ba of the plate spring 40B) extends along the second direction Y. Then, as illustrated in FIG. 22, the end part 42Ba (bent part 42Ba1) of the plate spring 40B on the other side Y2 in the second direction Y is inserted to the insertion port 23t of the biasing member holding part 23B. The end part 42Ba of the plate spring 40B on the other side Y2 in the second direction Y is inserted in such a way that the inclined contact part 42B on the other side Y2 in the second direction Y is disposed so that the biasing member side inclined contact surface 43 of the plate spring 40B and the sidewall part side inclined contact surface 23Bd face each other substantially in the third direction Z. At this time, a surface 42Bb of the inclined contact part 42B including the biasing member side inclined contact surface 43 in the plate spring 40B on the other side Z2 in the third direction Z and the surface 12a of the second core 12 on one side Z1 in the third direction Z are brought in contact with each other so that the inclined contact part 42B including the biasing member side inclined contact surface 43 is inserted to the insertion port 23t by sliding. This is suitable because the work is facilitated. Then, the inclined contact part 42B of the plate spring 40B on one side Y1 in the second direction Y is pushed toward the other side Z2 in the third direction Z, that is, the bent end part 46 of the plate spring 40B is pushed toward the biasing member locking part 25. At this time, the biasing member side inclined contact surface 43 of the plate spring 40B shifts to one side Z1 in the third direction Z, which brings the biasing member side inclined contact surface 43 and the sidewall part side inclined contact surface 23Bd into contact (surface contact) with each other. On the other hand, in the pushed-in bent end part 46 of the plate spring 40B, an outer side surface 46b3 of the bent locking part 46b is in sliding contact with the end surface 25c1 of the locking plate 25c, and the bent base part 46a is elastically curved. Then, in the bent locking part 46b, the guide inclined surface 25d1 of the locking projection 25d guides a projecting end part and the like of the bent locking part 46b in sliding contact, causing the projecting end 25d2 of the locking projection 25d to be fitted into the bent part 46b1 of the bent locking part 46b; thus, the state illustrated in FIG. 20 is obtained.

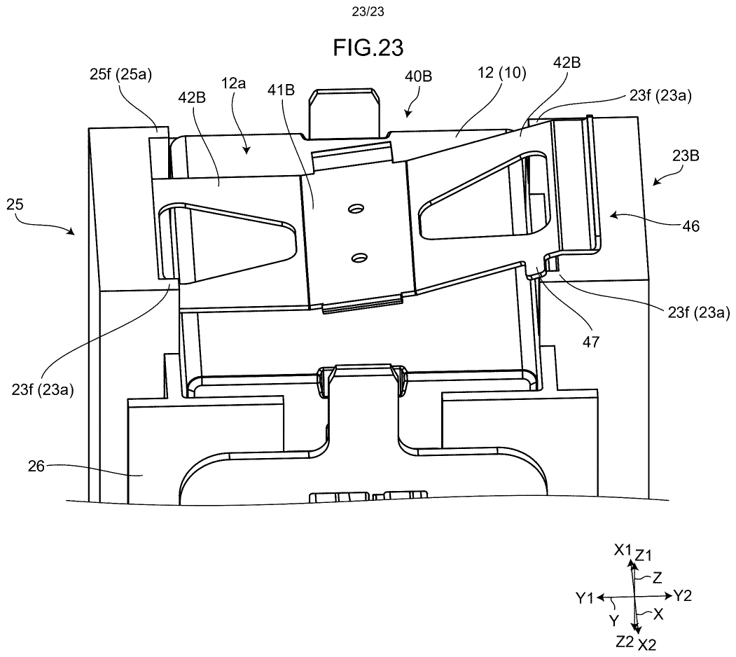

On the other hand, the incorrect assembly of the plate spring 40B is reduced by the interference of the attachment regulatory plate part 47 of the plate spring 40B with the biasing member holding part 23B. For example, as illustrated in FIG. 23, in the case where the plate spring 40B is attached to the base member 20B with the bent end part 46 of the plate spring 40B oriented to the other side Y2 in the second direction Y and the inclined contact part 42B including the biasing member side inclined contact surface 43 oriented to one side Y1 in the second direction Y, the attachment regulatory plate part 47 of the plate spring 40B interferes with the regulatory wall part 23f of the biasing member holding part 23B. Therefore, the plate spring 40B is not attached to the base member 20B in the wrong longitudinal direction, and problems such as detachment of the plate spring 40B due to such incorrect assembly are reduced.

The magnetic unit 1, 1A, 1B described above includes: the magnetic core 10 formed in the annular shape about the first direction X and including the first core 11 and the second core 12 split along the second direction Y that intersects with the first direction X, in which the second core 12 provided on one side Z1 in the third direction Z that intersects with the first direction X and the second direction Y and the first core 11 provided on the other side Z2 in the third direction Z are in contact with each other along the third direction Z; the base member 20, 20A, 20B that accommodates the magnetic core 10 and includes the bottom part 21 that supports the first core 11 and the sidewall part 22 that is provided on a side of the magnetic core 10 in the second direction Y; and the plate spring 40, 40A, 40B with the end part 42a, 42Aa, 42Ba in the second direction Y held by the sidewall part 22, the plate spring serving as the biasing member to bias the second core 12 to the other side Z2 in the third direction Z, in which the sidewall part 22 includes the biasing member holding part 23, 23A, 23B that is locked to the end part 42a, 42Aa, 42Ba of the plate spring 40, 40A, 40B, the plate spring 40, 40A, 40B includes the biasing member side inclined contact surface 43 formed with inclination to the surface on one side Z1 in the third direction Z, and the biasing member holding part 23 includes the sidewall part side inclined contact surface 23d, 23Ad, 23Bd formed with inclination so as to be in surface contact with the biasing member side inclined contact surface 43 while the plate spring 40, 40A, 40B is in the biased state.

When the plate spring 40, 40A, 40B is assembled to the base member 20, 20A, 20B, such a structure makes it possible to assemble directly the plate spring 40, 40A, 40B to the base member 20, 20A, 20B without sub-assembling, for example, assembling the plate spring 40, 40A, 40B to the cover member in advance. Then, the plate spring 40, 40A, 40B can be locked by bringing the biasing member side inclined contact surface 43 and the sidewall part side inclined contact surface 23d, 23Ad, 23Bd in surface contact with each other using the biasing force of the plate spring 40, 40A, 40B. The surface contact, which can increase the frictional force, makes it difficult to cause misalignment of the plate spring 40, 40A, 40B with respect to the biasing member holding part 23, 23A, 23B. In this way, the plate spring 40, 40A, 40B can be fixed suitably while making the locking structure of the plate spring 40, 40A, 40B easy to assemble and simple, and the configuration for assembling the plate spring 40, 40A, 40B, which is used as the biasing member, to the case including the base member 20, 20A, 20B can be properly achieved.

In addition, the plate spring 40, 40A, 40B includes the biasing contact part 41, 41A, 41B to be in contact with the second core 12, and the inclined contact part 42, 42A, 42B in which the biasing member side inclined contact surface 43 is provided, the inclined contact part being inclined from one side Z1 to the other side Z2 in the third direction Z from the end part 42a, 42Aa, 42Ba in the second direction Y toward the biasing contact part 41, 41A, 41B along the second direction Y. Thus, the plate spring 40, 40A, 40B made of the sheet metal material, which has a simple structure and maintains a strong biasing force, can be used as the biasing member, making it possible to bias so as to properly hold the magnetic core 10.

In addition, the biasing member holding part 23 is provided in each of the sidewall parts 22 provided on one side Y1 and the other side Y2 in the second direction Y, the biasing member holding part 23 on one side Y1 in the second direction Y includes the mountain-shaped projection 23e on one side X1 of the sidewall part side inclined contact surface 23d provided along the first direction X and the regulatory wall part 23f on the other side X2 of the sidewall part side inclined contact surface 23d, and the biasing member holding part 23 on the other side Y2 in the second direction Y includes the mountain-shaped projection 23e on the other side X2 of the sidewall part side inclined contact surface 23d provided along the first direction X and the regulatory wall part 23f on one side X1 of the sidewall part side inclined contact surface 23d. Thus, the plate spring 40 can be easily assembled to the base member 20 by rotating the plate spring 40 about the axial center CL3 of the base member 20 along the third direction Z, thereby improving the workability of the assembly work.

In the biasing member holding part 23A, 23B, the regulatory wall part 23f is provided at each of both ends of the sidewall part side inclined contact surface 23Ad, 23Bd provided along the first direction X. As a result, the plate spring 40A, 40B can be locked to the biasing member holding part 23A, 23B simply by inserting the end part 42Aa, 42Ba of the plate spring 40A, 40B into the biasing member holding part 23A, 23B from the direction along the second direction Y. This can simplify the assembly work of the plate spring 40A, 40B.

In addition, the biasing member holding part 23A is provided in each of the sidewall parts 22 provided on one side Y1 and the other side Y2 in the second direction Y, and the central part of the plate spring 40A in the second direction Y has the mountain shape. This makes it possible to assemble the plate spring 40A to the base member 20A simply by the pinching operation of the plate spring 40A using the mountain-shaped part as the pinch part 45, which can further improve the workability in assembling the plate spring 40A.

The magnetic unit according to any of the embodiments of the present embodiment described above is not limited to the embodiment described above, and various changes can be made within the scope of the claims.

In the above description, the sidewall parts 22 of the base member 20, 20A, 20B are provided on one side Y1 and the other side Y2 in the second direction Y; however, the sidewall part 22 (and the biasing member holding part 23, 23A, 23B provided in the sidewall part 22) may be provided on only one of those sides and on the other, another configuration of locking the end part 42a, 42Aa, 42Ba of the plate spring 40, 40A, 40B may be formed. Although the plate spring 40, 40A, 40B is used as the biasing member, the biasing member in other forms can also be used.

The magnetic unit according to this embodiment may be configured by combining the components in the embodiments and modifications described above as appropriate.

The magnetic unit according to the present embodiment has the effect that the configuration for assembling the biasing member to the case can be properly achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A magnetic unit comprising:
a magnetic core formed in an annular shape about a first direction and including a first core and a second core split along a second direction that intersects with the first direction, in which the second core provided on one side in a third direction that intersects with the first direction and the second direction and the first core provided on the other side in the third direction are in contact with each other along the third direction;
a base member that accommodates the magnetic core and includes a bottom part that supports the first core and a sidewall part that is provided on a side of the magnetic core in the second direction; and
a biasing member with an end part in the second direction held by the sidewall part, the biasing member being configured to bias the second core to the other side in the third direction, wherein the sidewall part includes a biasing member holding part that is locked to the end part of the biasing member,
the biasing member includes a biasing member side inclined contact surface formed with inclination to a surface on one side in the third direction, and
the biasing member holding part includes a sidewall part side inclined contact surface formed with inclination so as to be in surface contact with the biasing member side inclined contact surface while the biasing member is in an biased state.

2. The magnetic unit according to claim 1, wherein
the biasing member includes a biasing contact part to be in contact with the second core, and an inclined contact part in which the biasing member side inclined contact surface is provided, the inclined contact part being formed so as to be inclined from one side to the other side in the third direction from each end part thereof in the second direction toward the biasing contact part along the second direction.

3. The magnetic unit according to claim 1, wherein
the biasing member holding part is provided in each of the sidewall parts provided on one side and the other side in the second direction,
the biasing member holding part on one side in the second direction includes a mountain-shaped projection on one side of the sidewall part side inclined contact surface provided along the first direction and a regulatory wall part on the other side of the sidewall part side inclined contact surface, and
the biasing member holding part on the other side in the second direction includes the mountain-shaped projection on the other side of the sidewall part side inclined contact surface provided along the first direction and the regulatory wall part on one side of the sidewall part side inclined contact surface.

4. The magnetic unit according to claim 2, wherein
the biasing member holding part is provided in each of the sidewall parts provided on one side and the other side in the second direction,
the biasing member holding part on one side in the second direction includes a mountain-shaped projection on one side of the sidewall part side inclined contact surface provided along the first direction and a regulatory wall part on the other side of the sidewall part side inclined contact surface, and
the biasing member holding part on the other side in the second direction includes the mountain-shaped projection on the other side of the sidewall part side inclined contact surface provided along the first direction and the regulatory wall part on one side of the sidewall part side inclined contact surface.

5. The magnetic unit according to claim 1, wherein
in the biasing member holding part, the regulatory wall part is provided at each of both ends of the sidewall part side inclined contact surface provided along the first direction.

6. The magnetic unit according to claim 2, wherein
in the biasing member holding part, the regulatory wall part is provided at each of both ends of the sidewall part side inclined contact surface provided along the first direction.

7. The magnetic unit according to claim 5, wherein
the biasing member holding part is provided in each of the sidewall parts provided on one side and the other side in the second direction, and
the biasing member includes a plate spring whose central part in the second direction has a mountain shape.

8. The magnetic unit according to claim 6, wherein
the biasing member holding part is provided in each of the sidewall parts provided on one side and the other side in the second direction, and
the biasing member includes a plate spring whose central part in the second direction has a mountain shape.
